(19) United States
(12) Patent Application Publication
(10) Pub. No.: US 2004/0230620 A1
(43) Pub. Date: Nov. 18, 2004

(54) System and method for electronic document control

(76) Inventors: Chung-I Lee, Tu-Chen (TW); Wei-Qing Xiao, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/847,696

(22) Filed: May 17, 2004

(30) Foreign Application Priority Data
May 16, 2003 (TW) 92113412

(51) Int. Cl. G06F 7/00

(52) U.S. Cl. 707/200

(57) ABSTRACT

A system for electronic document control includes a server computer (1), a Domino database (3), and a plurality of client computers (2). The server computer includes a Word document obtaining module (20), a Word document converting module (30), and a purview controlling module (40). The Word document obtaining module is used for obtaining a Microsoft Word document from any of the client computers. The Word document converting module is used for converting the Word document to a Notes document and storing the Notes document in the Domino database, analyzing directory structures of the Word document, distilling title types of the Word document and generating directory tree structures of the Word document, and for storing the directory tree structures and contents of the Word document in the Domino database. The purview controlling module is used for controlling accessing and printing purviews of the Notes document.

### BACKGROUND OF THE INVENTION

1. Field of the Invention

The present invention relates to systems and methods for management of electronic documents, and particularly to systems and methods for controlling accessing and printing of such documents.

2. Description of Related Art

With the so-called knowledge economy growing day by day, Office Automation (OA) and the Internet are gaining even more widespread use. These means speed up internal information exchange in an enterprise, streamline document management, increase work efficiency, reduce costs, and enhance competitiveness.

Taiwan Pat. No. 528956 issued on Apr. 21, 2003 and entitled “System And Method For Authorization Of Accessing Resources” discloses a method of accessing and browsing data. The system comprises a plurality of terminal apparatuses connected with an application software server computer of a vendor. Users of the terminal apparatuses can access the program of the application software server computer via the system. The system can transmit and access resources with active exchange visits between users and the system. Information obtained by a resource system browser of each terminal apparatus can be presented in Web page format to users.

The above-described system and method can achieve accessing and browsing of information. However, any number of users can directly browse any one document in, say, Microsoft Word document format or in Web page format, and can freely update and print the information of the document. That is, the security of the document cannot be ensured.

A system and method for electronic document control which overcomes the above-mentioned shortcomings is desired.

### SUMMARY OF THE INVENTION

An object of the present invention is to provide a system and method for electronic document control, in which the system and method can transfer a Microsoft Word document to a Domino database automatically, and then generate a corresponding Lotus Notes document.

Another object of the present invention is to provide a system and method for electronic document control, in which the system and method can control the accessing and printing purview of Notes documents in the above-mentioned Domino database.

To achieve the above-mentioned objects, a preferred embodiment of a system for electronic document control of the present invention comprises a server computer, a Domino database and a plurality of client computers. The server computer is connected with a Domino database via a database connectivity. The client computer accesses the server computer via a network. The Domino database is used for storing Notes documents. The client computer provides a user interface to access the Notes documents in the Domino database according to the purview. The server computer is a Lotus Domino Server and comprises a Word document obtaining module, a Word document converting module and a purview controlling module. The Word document obtaining module is used for obtaining a Microsoft Word document from any of the client computers. The Word document converting module is used for analyzing the directory structure of the Word document, distilling all of title types and generating directory tree structures of the Word document, and storing the directory tree structures and contents of the Word document in the Domino database. The Word document converting module comprises a Microsoft Word document directory structure analyzing sub-module, a directory tree structure generating sub-module, and a Notes document generating sub-module. The directory structure analyzing sub-module is used for analyzing the directory structure of the Word document; the directory tree structure generating sub-module is used for distilling all the title types according to the analyzing results of the directory structures analyzing sub-module, and for generating the directory tree structures; and the Notes document generating sub-module is used for generating a Notes document, and storing the directory tree structures and contents of the Word document and the Notes document in the Domino database. The purview controlling module is used for controlling users' accessing and printing purviews of the stored Notes document in the Domino database. The purview controlling module comprises an accessing purview controlling sub-module, and a printing purview controlling sub-module. The accessing purview controlling sub-module is used for controlling the accessing purview of the Notes document; and the printing purview controlling sub-module is used for controlling the printing purview of the Notes document.

Further, a preferred method for electronic document control is provided by the present invention. The method employs the above-described system. In the method, the Word document converting module converts an obtained Word document into a Notes document. The user can then browse the Notes document with a Lotus Notes client in Web page format. Therefore, the security of the Notes document is ensured. The method comprises the following steps: (a) the Word document obtaining module obtains a Microsoft Word document from any of the client computers; (b) the Word document directory structure analyzing sub-module analyzes the directory structures of the Word document; (c) the directory tree structure generating sub-module distills all the title types of the Word document; (d) the directory tree structure generating sub-module generates the directory tree structures; (e) the Notes document generating sub-module generates a Notes document and stores the analyzing results and the Notes document in the Domino database; and (f) the purview controlling module controls the purviews of accessing and printing of the Notes document.

Other objects, advantages and novel features of the present invention will be drawn from the following detailed description of preferred embodiments of the present invention with the attached drawings, in which:

### BRIEF DESCRIPTION OF THE DRAWINGS

FIG. 1 schematically shows hardware infrastructure of a system for electronic document control in accordance with the preferred embodiment of the present invention;

FIG. 2 is a schematic diagram of software function module infrastructure of a server computer of the system of FIG. 1;

FIG. 3 is a data flowchart of electronic document control in accordance with the present invention; and

FIG. 4 is a flowchart of a preferred method for electronic document control of the present invention.

### DETAILED DESCRIPTION OF THE INVENTION

Reference will now be made to the drawing figures to describe the present invention in detail.

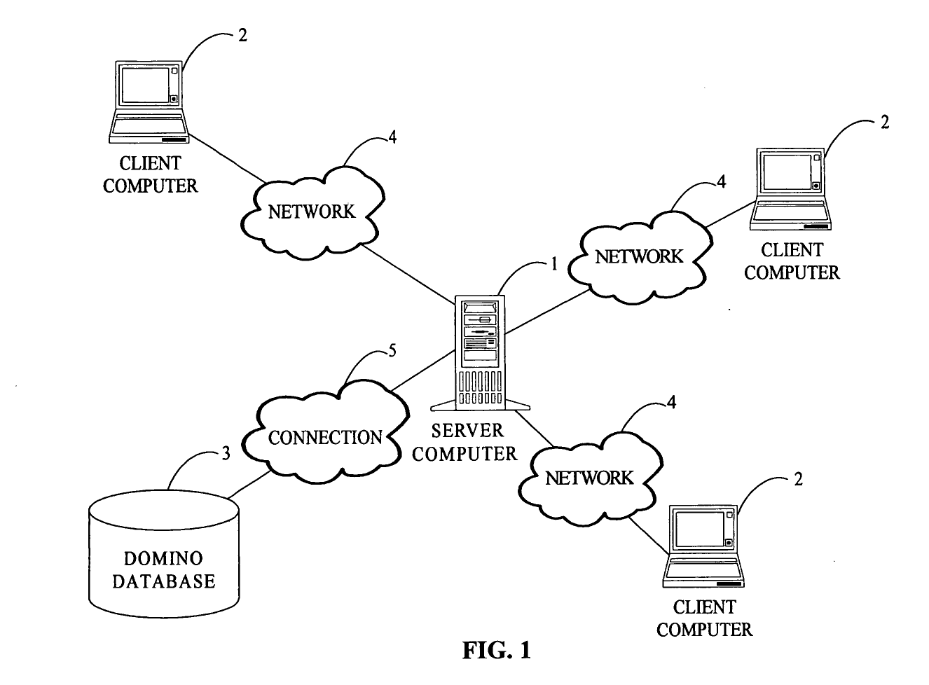

FIG. 1 schematically shows hardware infrastructure of a system for electronic document control in accordance with the preferred embodiment of the present invention. The system comprises a server computer 1, a plurality of client computers 2, a Domino database 3 connected with the server computer 1 via a connection 5, and a network 4 connecting the server computer 1 with the client computers 2. The network 4 is an electronic communications network, which may be an intranet, the Internet or another suitable type of network. The connection 5 is a database connectivity, such as an Open Database Connectivity (ODBC) or a Java Database Connectivity (JDBC).

The server computer 1 is a Lotus Domino Server. The server computer 1 comprises a series of software function modules, for obtaining a Microsoft Word document from any of the client computers 2, converting the Word document to a Lotus Notes document and storing the Notes document in the Domino database 3.

Each of the client computers 2 is installed with an operating system such as Microsoft Windows95, Windows98, WindowsNT, etc. Each client computer 2 provides an interface for users to obtain a desired Word document, and to read, write, edit and print the corresponding Notes document. The Domino database 3 is used for storing converted Notes document.

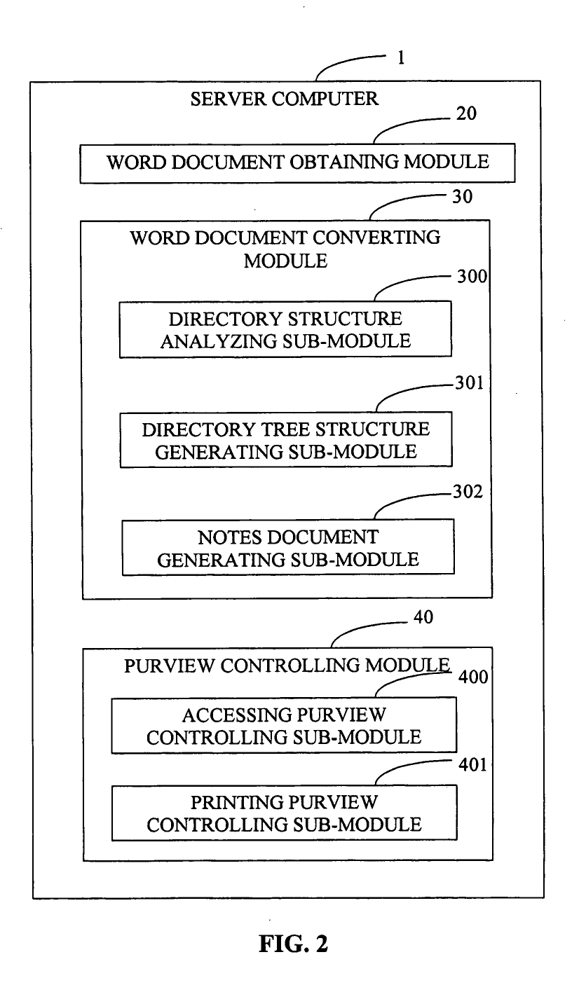

FIG. 2 is a schematic diagram of software function module infrastructure of the server computer 1. The server computer 1 comprises a Word document obtaining module 20, a Word document converting module 30, and a purview controlling module 40. The Word document obtaining module 20 is used for obtaining a Microsoft Word document from any of the client computers 2.

The Word document converting module 30 comprises a directory structure analyzing sub-module 300, a directory tree structure generating sub-module 301, and a Notes document generating sub-module 302. The directory structure analyzing sub-module 300 is used for analyzing the directory structure of the obtained Word document based on Word COM (Component Object Model) programming and LotusScript script programming, whose pseudo codes are described as:

Forall para In Worddoc.paragraphs

If Left$(strStyle, 2)=“title” And Len

(strStyle)>=2 Then

End if

End Forall

The directory tree structure generating sub-module 301 is used for distilling all the title types according to the analysis results of the directory structure analyzing sub-module 300, and for generating directory tree structures. The Word document directory is used for loading chapter or section titles and sub-titles of the Word document. The type is a compounding of the Word document applying to a series of characters format and the paragraph format. The title is a basis for establishing the Word document directory and index. The Notes document generating sub-module 302 is used for generating a Notes document, and storing the directory tree structures and contents of the Word document and the Notes document in the Domino database 3.

The purview controlling module 40 comprises an accessing purview controlling sub-module 400, and a printing purview controlling sub-module 401. The accessing purview controlling sub-module 400 is used for controlling the users' accessing purview of the Notes document of the Domino database 3, and for initializing a Default and Anonymous property of an ACL (Access Control List) of the Domino database 3 as a no accessing purview. The printing purview controlling sub-module 401 is used for controlling the printing purview of the Notes document in the Domino database 3. For example, the printing purview controlling sub-module 401 may forbid printing of the Notes document in the Domino database 3, in which case the pseudo code is described as:

NotesDocument.˜$keepPrivate=“1”

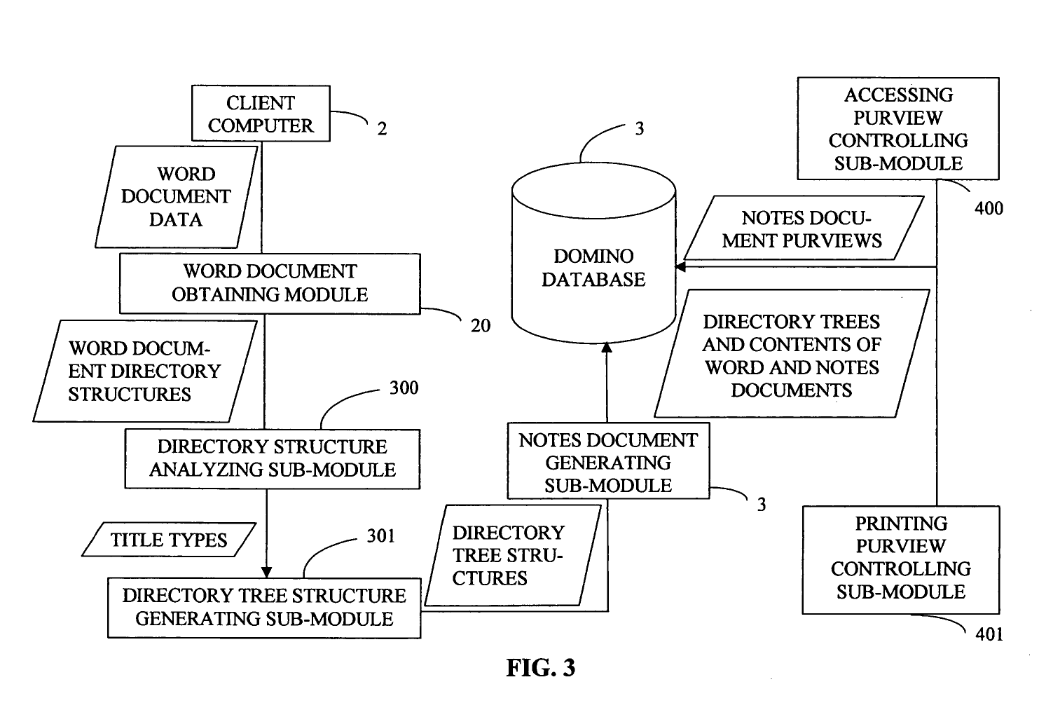

FIG. 3 is a data flowchart for electronic document control in accordance with the present invention. The Word document obtaining module 20 obtains the Word document data from any of the client computers 2, and analyzes the Word document directory structures via the directory structure analyzing sub-module 300 based on the Word COM programming and the LotusScript script programming. The directory tree structure generating sub-module 301 distills all the title types, and generates the directory tree structures. The Notes document generating sub-module 302 generates a Notes document, and stores the directory tree structures and contents of the Word document and the Notes document in the Domino database 3. The accessing purview controlling sub-module 400 controls the accessing purview of the Notes document in the Domino database 3. The printing purview controlling sub-module 401 controls the printing purview of the Notes document in the Domino database 3.

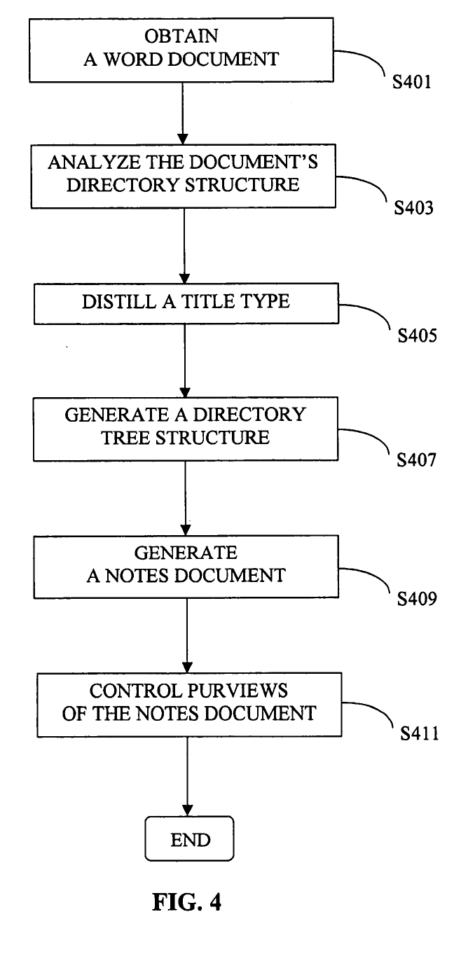

FIG. 4 is a flowchart of a preferred method for electronic document control in accordance with the present invention. In step S401, the Word document obtaining module 20 obtains Microsoft Word document data from any of the client computers 2. In step S403, the Word document directory structure analyzing sub-module 300 analyzes the directory structure of the Word document. In step S405, the directory tree structure generating sub-module 301 distills all the title types according to the analyzed results. In step S407, the directory tree structure generating sub-module 301 generates directory tree structures. In step S409, the Notes document generating sub-module 302 generates a Notes document, and stores the directory tree structures and contents of the Word document and the Notes document in the Domino database 3. In step S411, the purview controlling module 40 controls the purviews of accessing and printing of the Notes document in the Domino database 3.

In general, the system and method for electronic document control of the present invention may take forms other than what is described above. While preferred embodiments for carrying out the invention have been described in detail, those familiar with the art to which the invention relates will recognize various alternative designs and embodiments for practicing the invention. In particular, it will be apparent that the invention is not restricted to Word documents, Notes documents and a Domino database. Other suitable kinds of documents and databases may be employed to practice the present invention. For example, text-based documents, network browser compatible documents and a network browser compatible document database may be employed. These and other alternative embodiments are within the scope of the present invention, which is defined by the claims appended hereto and allowable equivalents thereof.

What is claimed is:

1. A system for electronic document control, the system comprising a Domino database and a plurality of client computers all connected with a server computer, wherein:
the Domino database is used for storing Lotus Notes documents; and
the server computer comprises:
a Word document obtaining module for obtaining a Microsoft Word document from any one of the client computers;
a Word document converting module for converting the Word document to a Notes document and storing the Notes document in the Domino database, for analyzing directory structures of the Word document, distilling title types of the Word document and generating directory tree structures of the Word document, and for storing the directory tree structures and contents of the Word document in the Domino database; and
a purview controlling module for controlling reading, writing, editing and printing the Notes document in the Domino database.

2. The system for electronic document control as described in claim 1, wherein the server computer is a Lotus Domino Server.

3. The system for electronic document control as described in claim 1, wherein the Word document converting module comprises:
a directory structure analyzing sub-module for analyzing the directory structure of the Word document based on Word component object model programming and LotusScript script programming;
a directory tree structure generating sub-module for distilling all of title types according to results of analysis of the directory structure analyzing sub-module, and for generating directory tree structures; and
a Notes document generating sub-module for generating a Notes document, and storing the directory tree structures and contents of the Word document and the Notes document in the Domino database.

4. The system for electronic document control as described in claim 1, wherein the purview controlling module comprises:
an accessing purview controlling sub-module for controlling an accessing purview of the Notes document; and
a printing purview controlling sub-module for controlling a printing purview of the Notes document.

5. A method for electronic document control, the method comprising the following steps:
obtaining a Microsoft Word document;
analyzing the Word document's directory;
distilling title types of the Word document;
generating directory tree structures of the Word document;
forming a Lotus Notes document;
storing the directory tree structures and contents of the Word document and the Notes document in a Domino database; and
controlling purviews of accessing and printing of the Notes document.

6. The method for electronic document control as described in claim 5, wherein the Microsoft Word document is obtained from any of the client computers.

7. The method for electronic document control as described in claim 5, wherein the step of analyzing the Word document's directory is based on Word component object model programming and LotusScript script programming.

8. The method for electronic document control as described in claim 5, wherein the step of controlling purviews of accessing and printing of the Notes document further comprises the step of initializing a Default and Anonymous property of an Access Control List of the Domino database as a no accessing purview.

9. A system for electronic document control, the system comprising a network browser compatible document database and a plurality of client computers connected with a server computer, wherein:
said database is used for storing network browser compatible documents; and
the server computer comprises:
a document obtaining module for obtaining a text-based document from any one of the client computers;
a document converting module for converting the text-based document to a network browser compatible document and storing the network browser compatible document in said database, for analyzing directory structures of the text-based document, distilling all of title types of the text-based document and generating directory tree structures of the text-based document, and for storing the directory tree structures and contents of the text-based document in said database; and
a purview controlling module for controlling reading, writing, editing and printing of the network browser compatible document in said database.

10. The system for electronic document control as described in claim 9, wherein the document converting module comprises:
a directory structure analyzing sub-module for analyzing the directory structures of the text-based document;
a directory tree structure generating sub-module for distilling all of title types according to results of analysis of the directory structure analyzing sub-module, and for generating the directory tree structures; and
a document generating sub-module for generating a network browser compatible document, and storing the directory tree structures and contents of the text-based document and the network browser compatible document in said database.

11. The system for electronic document control as described in claim 9, wherein the purview controlling module comprises:
an accessing purview controlling sub-module for controlling an accessing purview of the network browser compatible document; and
a printing purview controlling sub-module for controlling a printing purview of the network browser compatible document.

12. A method for electronic document control, the method comprising the following steps:
obtaining a text-based document;
analyzing the text-based document's directory;
distilling title types of the text-based document;
generating directory tree structures of the text-based document;
forming a network browser compatible document;
storing the directory tree structures and contents of the text-based document and the network browser compatible document in a network browser compatible database; and
controlling purviews of accessing and printing of the network browser compatible document.

13. The method for electronic document control as described in claim 12, wherein the text-based document is obtained from any of the client computers.

14. The method for electronic document control as described in claim 12, wherein the step of controlling purviews of accessing and printing of the network browser compatible document comprises forbidding accessing and printing of the network browser compatible document.
